(19) United States
(12) Patent Application Publication
(10) Pub. No.: US 2008/0172339 A1
(43) Pub. Date: Jul. 17, 2008

(54) METHOD AND SYSTEM FOR AUTHENTICATING TRANSACTIONS

(76) Inventors: Robert Thomas Cato, Raleigh, NC (US); Phuc Ky Do, Morrisville, NC (US); Justin Monroe Pierce, Cary, NC (US)

Correspondence Address: DUKE W. YEE;YEE & ASSOCIATES, P.C., P.O. BOX 802333, DALLAS, TX, 75380, US

(21) Appl. No.: 11/623,543

(22) Filed: Jan. 16, 2007

(51) Int. Cl. G06Q 20/00; H04L 9/30

(52) U.S. Cl. 705/71; 705/1

(57) ABSTRACT

The illustrative embodiments provide a method, an apparatus, and a computer usable program product for authenticating a transaction. A confirmation device receives an authentication data pattern from a data processing system, wherein the authentication data pattern is generated in response to completing a transaction processed by the data processing system. Responsive to receiving the authentication data pattern from the data processing system, the confirmation device monitors a transmission comprising the data pattern from a wireless mobile device. Responsive to receiving the transmission comprising the data pattern from the wireless mobile device, the confirmation device authenticates the data pattern from the wireless mobile device using an authentication form.

### BACKGROUND OF THE INVENTION

1. Field of the Invention

The present invention relates generally to an improved data processing system. More particularly, the present invention relates to a method, a system, and a computer usable program code for authenticating transactions.

2. Description of the Related Art

The advent of wireless mobile devices and the internet creates the possibility of different methods for authenticating transactions. For example, in the retail industry, the concept of a checkout station is being completely modified because customers using a wireless mobile device can select and purchase a product in the store without physically walking through a checkout station. The customer simply needs a network connection to the retail establishment in order to complete the transaction.

Because of the ease with which a customer can purchase a product, difficulty arises with the method of authenticating or verifying that the customer actually purchased the product prior to leaving a business entity. One solution is to station an employee at an exit and have the employee compare a printed receipt against the product that the customer purchased. However, the solution requires the business entity have a station that prints receipts. In turn, customers are then required to find the station and print the receipt prior to leaving the business entity. If the customer's wireless mobile device also needs to wirelessly or physically connect to the station, the customer must also spend time determining how to link the wireless mobile device to the station. If issues arise in establishing the link, the customer has to wait for an employee to address the situation. In the end, the time to print the receipt can exceed the time for the customer to checkout using traditional means.

### BRIEF SUMMARY OF THE INVENTION

The illustrative embodiments provide a method, an apparatus, and a computer usable program product for authenticating a transaction. A confirmation device receives an authentication data pattern from a data processing system, wherein the authentication data pattern is generated in response to completing a transaction processed by the data processing system. Responsive to receiving the authentication data pattern from the data processing system, the confirmation device monitors a transmission comprising a data pattern from a wireless mobile device. Responsive to receiving the transmission comprising the data pattern from the wireless mobile device, the confirmation device authenticates the data pattern from the wireless mobile device using an authentication form.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates a network of data processing systems, in which an illustrative embodiment may be implemented;

FIG. 2 is a block diagram of a data processing system, in which an illustrative embodiment may be implemented;

FIG. 3 is a block diagram of a wireless mobile device, in which an illustrative embodiment may be implemented;

FIG. 4 illustrates a validation system for a business entity, in accordance with an illustrative embodiment;

FIG. 5 graphically illustrates various illustrative embodiments for authenticating a confirmation, in accordance with an illustrative embodiment;

FIG. 6 is a flowchart illustrating the process for authenticating a transaction in which the confirmation device receives a data pattern from both the business entity and the wireless mobile device, in accordance with an illustrative embodiment;

FIG. 7 is a flowchart illustrating the process for authenticating a transaction in which the confirmation device receives a data pattern only from the wireless mobile device, in accordance with an illustrative embodiment;

FIG. 8 is a flowchart illustrating the method for creating a secure data pattern for a validation system in which the confirmation device receives a data pattern from both the business entity and the wireless mobile device, in accordance with an illustrative embodiment; and

FIG. 9 is a flowchart illustrating the method for creating a secure data pattern for a validation system in which the confirmation device receives a data pattern only from the wireless mobile device, in accordance with an illustrative embodiment.

### DETAILED DESCRIPTION OF THE INVENTION

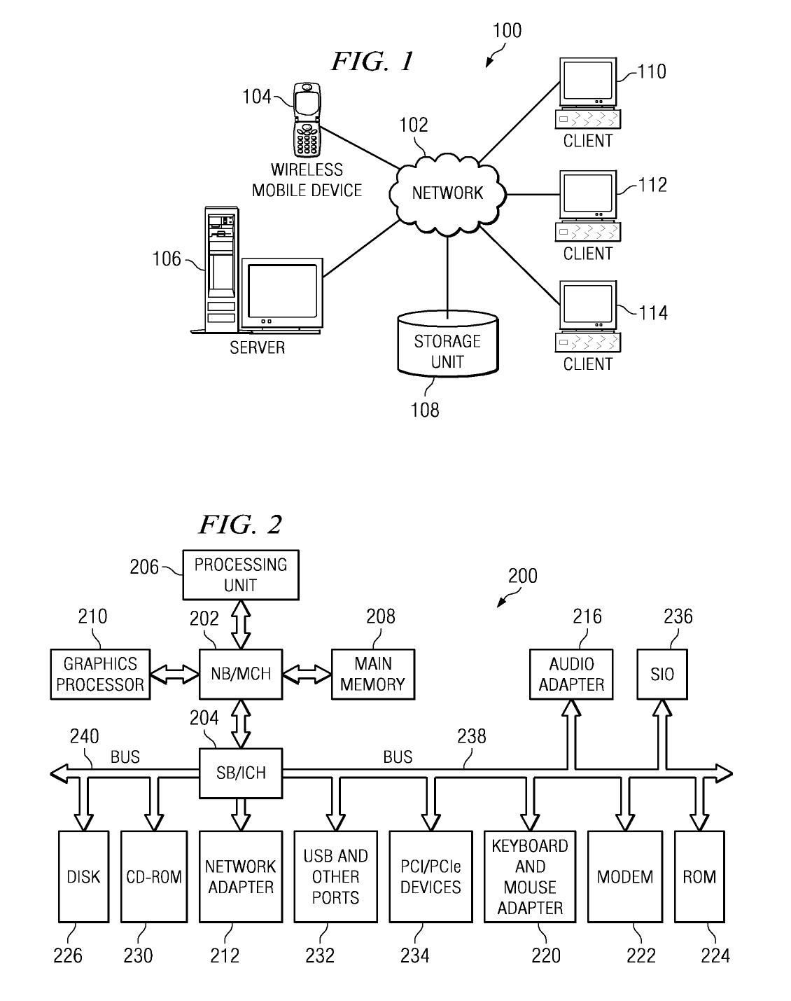

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communication links between various devices and computers connected together within network data processing system 100. Network 102 may include connections, such as wire, wireless communication links, or fiber optic cables.

In the depicted example, wireless mobile device 104, server 106, storage unit 108, and clients 110, 112, and 114 connect to network 102. In another embodiment, wireless mobile device 104 can also connect to clients 110, 112, and 114 using a short range wireless link, such as infrared or Bluetooth®. Bluetooth® is a trademark of Bluetooth SIG, Inc. in the United States, other countries, or both.

Clients 110, 112, and 114 may be, for example, personal computers or network computers. In the depicted example, server 106 provides data, such as boot files, operating system images, and applications, to clients 110, 112, and 114. Clients 110, 112, and 114 are clients to server 106 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example and not as an architectural limitation for different embodiments.

With reference now to FIG. 2, a block diagram of a data processing system is shown in which illustrative embodiments may be implemented. Data processing system 200 is an example of a computer, such as server 106 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204, and audio adapter 216, keyboard and mouse adapter 220, modem 222, read only memory (ROM) 224, universal serial bus (USB) and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. An example of a USB device that can be attached to USB and other communications ports 232 is a short range wireless adapter, such as a Bluetooth® or infrared adapter. PCI/PCIe devices may include, for example, Ethernet adapters, add-in cards, and PC cards for notebook computers. Other examples of PCI/PCIe cards are short range wireless adapters such as Bluetooth® or infrared adapters. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Red Hat® or Microsoft® Windows® XP. Red Hat® is a registered trademark of Red Hat, Inc. Microsoft® and Windows® are trademarks of Microsoft Corporation in the United States, other countries, or both. An object-oriented programming system, such as the Java® programming system, may run in conjunction with the operating system and provides calls to the operating system from Java® programs or applications executing on data processing system 200. Java® and all Java®-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and the above-described examples are not meant to imply architectural limitations. For example, data processing system 200 also may be a tablet computer, a laptop computer, or a telephone device, in addition to taking the form of a PDA.

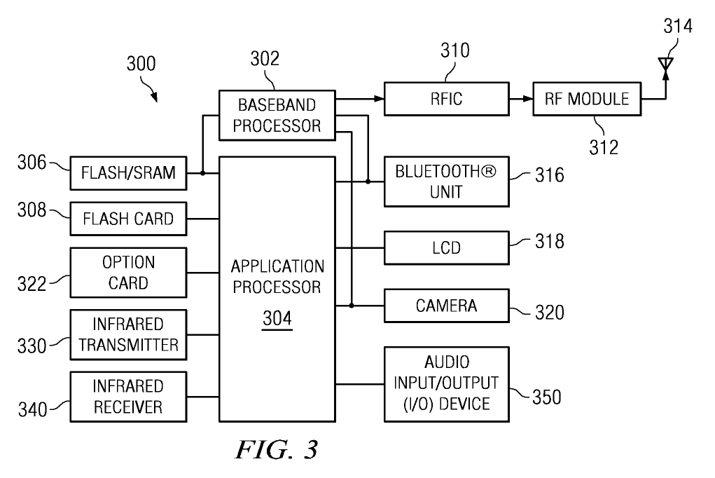

FIG. 3 is a block diagram of a wireless mobile device, in which an illustrative embodiment may be implemented. Wireless mobile device 300 may be a cellular phone, a personal digital assistant (PDA), or a pager. Wireless mobile device 300 includes baseband processor 302, application processor 304, flash/static random access memory (SRAM) 306, flash card 308, radio frequency integrated circuit (RFIC) 310, radio frequency (RF) module 312, antenna 314, Bluetooth® unit 316, liquid crystal display (LCD) 318, camera 320, option card 322, infrared transmitter 330, infrared receiver 340, and audio input/output (I/O) device 350.

Baseband processor 302 provides for wireless receiver and transmitter operations and is commonly referred to as a transceiver. In particular, baseband processor 302 handles the entire audio, signal, and data processing requirements needed to receive and send data using radio frequency (RF) transmissions or Bluetooth® transmissions. Application processor 304 provides the processing power for other functions within wireless mobile device 300. Example functions include, but are not limited to, calculators, calendars, alarms, camera functions, encryption and decryption functions, and directories. Flash/SRAM 306 is a storage device in which various instructions for providing the functions and upgrades within wireless mobile device 300 are located. Flash card 308 is a storage device in which user data and applications may be stored. An example of flash card 308 is a secure digital card.

A pathway for the transmission of voice and other types of data is provided through radio frequency integrated circuit (RFIC) 310, radio frequency (RF) module 312, and antenna 314. Additionally, short range transmissions may be sent or received through Bluetooth® unit 316 via an antenna within Bluetooth® unit 316. Furthermore, short range transmissions may also be sent or received through infrared transmitter 330 and infrared receiver 340.

In the illustrative embodiment, Bluetooth® unit 316 conforms to the Bluetooth® wireless specification, which defines the link and application layers for Bluetooth® developers. In the illustrative embodiments, voice transmissions, other types of data transmissions, and short range transmissions are made via an antenna packaged within Bluetooth® unit 316.

LCD 318 is a display for pictures and other data for wireless mobile device 300. Camera 320, in this example, is a complementary metal oxide semiconductor (CMOS) camera which may be built into wireless mobile device 300 or connected to wireless mobile device 300 as a separate module, such as option card 322. Option card 322 may be any integrated circuit card and may also contain other application-specific functions, such as a global positioning system (GPS).

Camera 320 forms the camera module of wireless mobile device 300, while the other components form the digital phone module of wireless mobile device 300 in the illustrative embodiment. Also, in the illustrative embodiment, instructions are added to wireless mobile device 300 to allow wireless mobile device 300 to validate a transaction that was completed using wireless mobile device 300. Instructions are also included in wireless mobile device 300 to allow wireless mobile device 300 to interact with external network systems.

Infrared transmitter 330 and infrared receiver 340 connect to application processor 304. Infrared transmitter 330 and infrared receiver 340 allow wireless mobile device 300 to send infrared signals to and to receive infrared signals from an infrared sensor.

Audio I/O device 350 connects to application processor 304 and can receive audio sounds, such as music or a human voice, transmitted from another source. Audio I/O device 350 also provides audio indications to the user of wireless mobile device 300. Example audio indications include phone messages, ring tones, and user guidance tones, such as a beep when a keypad button is pushed.

The illustrative embodiments provide a method, an apparatus, and a computer usable program product for authenticating transactions. A confirmation device receives an authentication data pattern from a data processing system. A confirmation device can be at least one of a computer, a personal digital assistant, a wireless mobile device, an infrared sensor, a camera, and a human being. The authentication data pattern is generated in response to completing a transaction processed by the data processing system. In response to receiving the authentication data pattern, the confirmation device monitors a transmission comprising a data pattern from a wireless mobile device. In response to an absence of the transmission comprising the data pattern within a period of time, the confirmation device notifies a business entity to investigate further. In response to receiving the transmission comprising the data pattern from the wireless mobile device, the confirmation device authenticates the data pattern from the wireless mobile device using an authentication form. The authentication of the data pattern is a communication sent by the business entity. The authentication form is at least one of a visual confirmation, an audible confirmation, or a wireless transmission.

In one embodiment, the authentication data pattern and the data pattern from the wireless mobile device are not encrypted. In another embodiment, the data processing system encrypts the authentication data pattern and the data pattern from the wireless mobile device using a private key for the business entity. Thus, in response to receiving an encrypted authentication data pattern, the confirmation device decrypts the encrypted authentication data pattern using the public key for the business entity. The confirmation device also decrypts the encrypted data pattern from the wireless mobile device using the public key for the business entity.

In another embodiment, the data pattern from the wireless mobile device is also encrypted using the public key for the wireless mobile device. Thus, the data pattern from the wireless mobile device is first encrypted with the private key for the business entity, and then encrypted for a second time using the public key for the wireless mobile device. In response to receiving a twice-encrypted data pattern from the wireless mobile device, the confirmation device first decrypts the twice-encrypted data pattern from the wireless mobile device using the public key from the wireless mobile device. The confirmation device then decrypts the data pattern a second time using the public key from the business entity.

In another embodiment, the confirmation device receives a data pattern from a wireless mobile device and not from a data processing system. In response to receiving the data pattern from the wireless mobile device, the confirmation device authenticates the data pattern using a public key from a business entity. The data pattern from the wireless mobile device is encrypted using a private key from the business entity.

In yet another embodiment, the data patterns are further validated by determining whether the authentication data pattern matches the data pattern from the wireless mobile device. The additional validation ensures that the data patterns are transmitted by the wireless mobile device and have not been intercepted by an unintended recipient. In response to an absence of a match, the confirmation device notifies the business entity to investigate further. The match is a known relationship between the authentication data pattern and the data pattern from the wireless mobile device. In other words, in this embodiment, the authentication data pattern and the data pattern from the wireless mobile device can be, but need not, be identical. If the authentication data pattern and the data pattern from the wireless mobile device are not identical, the confirmation device determines whether a known relationship exists between the authentication data pattern and the data pattern from the wireless mobile device. The known relationship can be, for example, a mathematical relationship, a password, or a time stamp.

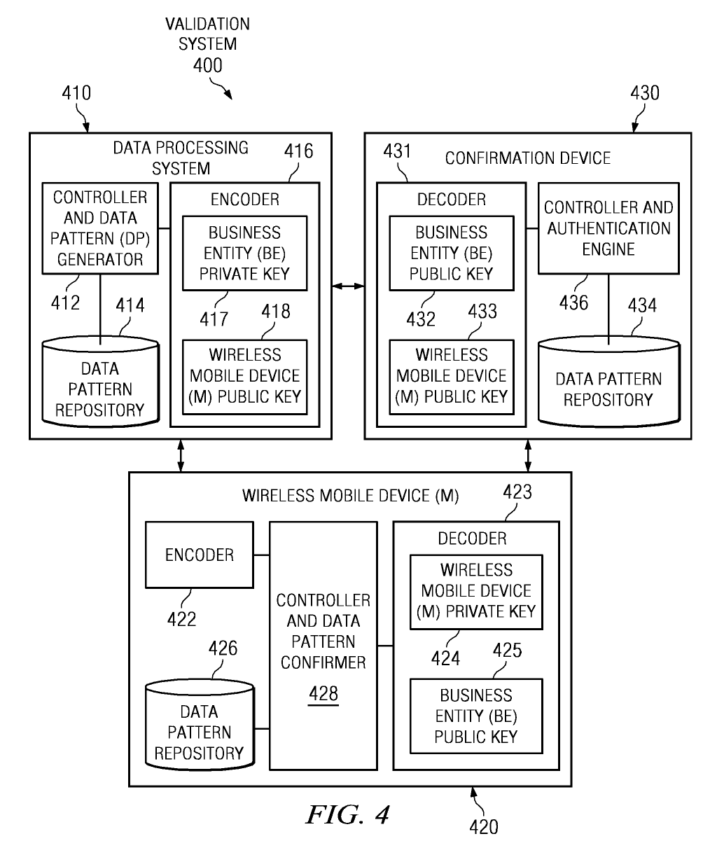

FIG. 4 illustrates a validation system for a business entity, in accordance with an illustrative embodiment. Validation system 400 can be implemented in any business entity, such as a grocery store, a bank, a movie theater, a venue for sporting events or concerts, or a registration booth for a marathon or a conference. In the illustrative embodiment, validation system 400 validates a transaction that was completed using a wireless mobile device.

In the illustrative embodiment, validation system 400 includes data processing system 410, wireless mobile device (M) 420, and confirmation device 430. Data processing system 410 is a computer, similar to clients 110, 112, and 114 of FIG. 1, and connects to wireless mobile device (M) 420 and confirmation device 430. Data processing system 410 functions to process and secure any transaction, such as a sales purchase, an account transfer, a loan approval transaction, or a confirmation for a marathon race registration. In other embodiments, data processing system 410 can take other forms, such as a PDA or a wireless mobile device.

In the illustrative embodiment, data processing system 410 includes controller and data pattern (DP) generator 412, data pattern repository 414, and encoder 416. Controller and data pattern (DP) generator 412 can be implemented in a processing unit, similar to processing unit 206 of FIG. 2. Controller and data pattern (DP) generator 412 executes instructions for generating a data pattern (DP). Example DPs include but are not limited to a digital proof of purchase, a digital receipt, or a registration confirmation. In the illustrative embodiment, the DP is confirmation of a completed transaction. Thus the DP can include any type of information related to the transaction, including, but not limited to, a description of the products, the price of the products, a transaction identification number, information about wireless mobile device (M) 420, information about the entities involved in the transaction (i.e. business entity details and customer details), and the time and date of the completed transaction. In other embodiments, the DP can include other non-financial data, such as the team affiliation or the seating preference of the user.

The DP also includes an authentication form that identifies the mechanism or form by which a business entity can authenticate the DP. Depending on the implementation, the authentication form can be a visual confirmation, an audio confirmation, or a wireless transmission.

The data used to generate the DP is stored in data pattern repository 414. Data pattern repository 414 connects to controller and data pattern (DP) generator 412. Data pattern repository 414 can be implemented as a separate storage unit, such as storage 108 of FIG. 1, or as part of the storage system within a data processing system, similar to main memory 208 or disk 226 of FIG. 2. The data stored in data pattern repository 414 can be stored in any format, including but not limited to a table, a flat file, an Extensible Markup Language (XML) file, a relational database management system, or any combination thereof. In the illustrative embodiment, data pattern repository 414 is in the main memory of data processing system 410 and stores data in a table.

In addition to the data used for the DP, data pattern repository 414 can also store personal information about a user, such as the name, address, and phone number of the user. Data pattern repository 414 can also store any information associated with completing a transaction within the business entity, such as the type of transaction the user is requesting, any information on the product, such as the quantity and availability of the product, or payment information, such as a credit card number. Furthermore, data pattern repository 414 can also store user related information, such as the buying history of the user or the customer loyalty status of the user.

The customer loyalty status indicates whether a user has a relationship with a business entity. For example, in one embodiment, a customer loyalty status may be divided simply into member and non-member. In another embodiment, customer loyalty status may be categorized into different levels, such as platinum, gold, and silver levels, or business or individual member levels. The customer loyalty status may be static and never change or may be dynamic and change after a period of time. For example, if static, the customer loyalty status will remain at the level at which the user initially signed up, such as member or non-member. If dynamic, the level may be based on a number of criteria, such as the frequency of visits to a business entity and the amount spent at the business entity. The level would change based on increasing or decreasing numbers of visits or on changes in the amounts of money spent over a period of time. Furthermore, in another embodiment, the customer loyalty status may give specific benefits to a user, such as discounts or previews of particular new product lines.

Encoder 416 connects to controller and data pattern (DP) generator 412. Encoder 416 includes business entity (BE) private key 417 and wireless mobile device (M) public key 418. Encoder 416 is a device or algorithm that secures the data included in the DP. In the illustrative embodiment, encoder 416 encrypts data using a public/private key cryptography system which is a pair of cryptographic keys, a public key and a private key, which are mathematically related to each other. Only a corresponding public key can unlock the information secured by the private key. The public key is typically widely distributed and can only unlock information encoded with the corresponding private key. The private key is typically kept secret and maintained by the individual or the business entity that is securing the data. In one embodiment, the private and public keys can be static and unchanging. For security purposes, in another embodiment, the private and public keys are often dynamic and expire after a certain time period. In another embodiment, the private and public keys can be user or transaction specific. In other words, the private and public keys can change with each completed transaction or with each user.

Encoder 416 secures the data by encrypting the DP using BE private key 417 to form a business entity encrypted DP (BEDP). Encoder 416 sends an authentication data pattern or an instance of a BEDP to confirmation device 430. An authentication data pattern is the DP used by confirmation device 430 to determine that the data pattern is communicated by the business entity.

Encoder 416 may also ensure that the DP, if intercepted, may not be utilized by an unintended recipient or another wireless mobile device. Therefore, encoder 416 encodes BEDP using wireless mobile device (M) public key 418 to form a mobile device encrypted BEDP (MBEDP). Encoder 416 communicates the public key for the business entity to a recipient device, which in the illustrative embodiment is wireless mobile device (M) 420 and confirmation device 430.

Wireless mobile device (M) 420 is any device that can request a transaction and communicate the completion of the transaction. In the illustrative embodiment, wireless mobile device (M) 420 can be any wireless device, such as a wireless phone, a personal digital assistant (PDA), or a laptop computer. Wireless mobile device (M) 420 can be implemented as wireless mobile device 300 of FIG. 3. In an alternative embodiment, wireless mobile device (M) 420 can be a wired device which is directly connected to a network or a power source.

In the illustrative embodiment, wireless mobile device (M) 420 connects to data processing system 410 and confirmation device 430 via an internal or external network. An internal network is a network specific to the business entity. An external network is a network that connects multiple users and business entities together, similar to network 102 of FIG. 1. In the illustrative embodiment, validation system 400 uses an external network.

In the illustrative embodiment, wireless mobile device (M) 420 includes encoder 422, decoder 423, data pattern repository 426, and controller and data pattern confirmer 428. Encoder 422 and decoder 423 are executed in an application processor, similar to application processor 304 of FIG. 3. Encoder 422 is similar to encoder 416, except that encoder 422 encrypts information sent from wireless mobile device (M) 420. In the illustrative embodiment, encoder 422 provides a public key specific to wireless mobile device (M) 420. The public key allows for any individual or business entity to encrypt data specifically intended for wireless mobile device (M) 420. In the illustrative embodiment, encoder 422 transmits a public key to data processing system 410.

Decoder 423 connects to controller and data pattern confirmer 428. Decoder 423 includes wireless mobile device (M) private key 424 and business entity (BE) public key 425. Decoder 423 decrypts any encrypted data transmitted to wireless mobile device (M) 420. In the illustrative embodiment, the DP is encrypted twice: (1) first by data processing system 410 using BE private key 417 to form the BEDP; and (2) second by data processing system 410 using M public key 418 to form the MBEDP. The first level of encryption ensures that the DP is created by the business entity in which the transaction was completed. In the illustrative embodiment, the first level of encryption ensures that data processing system 410 processed the request from wireless mobile device (M) 420 and generated the DP. The second level of encryption ensures that the DP is only utilized by wireless mobile device (M) 420. Thus, in the illustrative embodiment, the second level of encryption ensures that only the DP is utilized by the user of wireless mobile device 420.

The two levels of encryption establish a secure communications link between a specific wireless mobile device and a specific business entity. In this manner, in the illustrative embodiment, the business entity is able to identify and confirm the wireless mobile device performing the transaction. Likewise, the wireless mobile device performing the transaction is able to recognize and identify the business entity with which the wireless mobile device is interacting.

Since the DP is encrypted twice, the DP is also decrypted twice by decoder 423. During the first decryption, decoder 423 uses M private key 424 to decrypt and derive the BEDP. The first level of decryption by decoder 423 ensures that the DP is intended specifically for wireless mobile device (M) 420. Decoder 423 then decrypts the DP a second time using BE public key 425 to derive the DP. The second level of decryption identifies that the DP is transmitted from data processing system 410.

Data pattern repository 426 is connected to controller and data pattern confirmer 428 and is a storage device that stores the data pattern generated and transmitted by data processing system 410. Data pattern repository 426 also stores the DP that is to be transmitted by wireless mobile device (M) 420 to confirmation device 430. Data pattern repository 426 can be implemented as flash/SRAM, such as flash/SRAM 306 of FIG. 3, or as a flash card, such as flash card 308 of FIG. 3. The data stored in data pattern repository 426 can be stored in any format, including but not limited to a table, a flat file, an Extensible Markup Language (XML) file, a relational database management system, or any combination thereof. In the illustrative embodiment, data pattern repository 426 is in the flash card of wireless mobile device (M) 420 and stores data in a flat file.

Controller and data pattern confirmer 428 is coupled to encoder 422, decoder 423, and data pattern repository 426. Controller and data pattern confirmer 428 is a device that communicates to a business entity and to a user of wireless mobile device (M) 420 that a transaction was completed between the business entity and wireless mobile device (M) 420. Thus, controller and data pattern confirmer 428 transmits the BEDP to confirmation device 430. Controller and data pattern confirmer 428 can be implemented in the application processor, similar to application processor 304 of FIG. 3, of wireless mobile device (M) 420. Depending on the implementation identified in the authentication form, controller and data pattern confirmer 428 visually, audibly, or wirelessly communicates the data pattern to a user and to confirmation device 430. In the illustrative embodiment, controller and data pattern confirmer 428 visually displays all or a portion of the DP to a user.

Confirmation device 430 is coupled to wireless mobile device (M) 420 and data processing system 410. Confirmation device 430 is a mechanism that validates or confirms the completion of a transaction. Essentially, in the illustrative embodiment, confirmation device 430 ensures that the user of wireless mobile device (M) 420 actually completed a transaction before the user leaves the premises of the business entity.

Depending on implementation, confirmation device 430 can receive a visual, audio, or wireless communication from wireless mobile device (M) 420. The form of validation of confirmation device 430 corresponds to the form with which wireless mobile device (M) 420 transmits the DP. Thus, confirmation device 430 can be any validation mechanism including but not limited to a data processing system, a camera, an infrared sensor, or a human being. In the illustrative embodiment, confirmation device 430 is a data processing system, similar to clients 110, 112, and 114 of FIG. 1 and data processing system 200 of FIG. 2.

In the illustrative embodiment, confirmation device 430 includes decoder 431, data pattern repository 434, and controller and authentication engine 436. Decoder 431 is similar to decoder 423 of wireless mobile device (M) 420. Decoder 431 can be implemented in a processing unit, similar to processing unit 206 of FIG. 2, of confirmation device 430. Decoder 431 decrypts any encrypted data transmitted to confirmation device 430. Decoder 431 includes business entity (BE) public key 432 and wireless mobile device (M) public key 433. In the illustrative embodiment, decoder 431 decrypts the BEDP transmitted by data processing system 410 and the BEDP transmitted by wireless mobile device (M) 420. Decoder 431 uses the public key from the business entity to decrypt both instances of the BEDP to derive two instances of the DP.

Confirmation device 430 stores the DPs in data pattern repository 434. The data stored in data pattern repository 434 can be stored in any format, including but not limited to a table, a flat file, an Extensible Markup Language (XML) file, a relational database management system, or any combination thereof. In the illustrative embodiment, data pattern repository 434 is in the main memory of confirmation device 430 and stores data in a table.

Controller and authentication engine 436 is coupled to decoder 431 and data pattern repository 434 and can be implemented in a processing unit of confirmation device 430. Controller and authentication engine 436 authenticates and validates the transaction completed by wireless mobile device (M) 420 with the business entity through data processing system 410. Specifically, controller and authentication engine 436 determines whether the DP transmitted by wireless mobile device (M) 420 is authentic and valid. The method of authentication depends on the implementation which is identified in the authentication form found in the DP.

In the illustrative embodiment, confirmation device 430 receives from data processing system 410 the BEDP. After decrypting the BEDP from data processing system 410 using BE public key 432, confirmation device 430 then identifies that wireless mobile device (M) 420 should be transmitting a similar BEDP. Confirmation device 430 then monitors all BEDP transmitted by all the wireless mobile devices in the business entity to identify the corresponding BEDP to be transmitted by wireless mobile device (M) 420.

Once confirmation device 430 receives the BEDP from wireless mobile device (M) 420, confirmation device 430 decrypts the BEDP using BE public key 432. If confirmation device 430 is able to decrypt the BEDP transmitted by wireless mobile device (M) 420, then the confirmation device can complete the authentication method to determine if the transaction is valid. If the transaction is determined to be valid, confirmation device 430 assigns a confirmed status to wireless mobile device (M) 420. A confirmed status indicates that a transaction has been completed, authenticated, and validated by the business entity. Typically, the confirmed status allows the user of wireless mobile device (M) 420 to leave the premises of the business entity. If, however, confirmation device 430 is not able to decrypt the BEDP transmitted by wireless mobile device (M) 420, then the transaction is invalid and confirmation device 430 notifies the business entity. The business entity can notify security to prevent the user of wireless mobile device 420 from leaving the premises or can notify another employee to further investigate the issue.

Additionally, in yet another embodiment, if, after a period of time, confirmation device 430 does not receive a transmission for the BEDP from wireless mobile device (M) 420, then confirmation device 430 notifies the business entity to investigate further. The period of time can be set by the business entity or can be a default setting. The period of time can range from anywhere between a few seconds to several hours. The absence of a transmission typically indicates that the user of wireless mobile device 420 completed a transaction, but probably has not left the premises of the business entity. In the illustrative embodiment, confirmation device 430 notifies the business entity if twenty minutes have passed and confirmation device 430 has not received the BEDP from wireless mobile device (M) 420.

In another embodiment, controller and authentication engine 436 can conduct an additional confirmation. The BEDP is authentic if decoder 431 is able to decrypt the BEDP, thereby indicating that the DP was sent by the business entity. The decrypted BEDP is valid if additional information within the DP can also be confirmed. In one embodiment, controller and authentication engine 436 can validate a DP by determining whether the DP transmitted by wireless mobile device (M) 420 matches the DP transmitted by data processing system 410. If both DPs match, then the transaction is valid. If the DPs do not match, then confirmation device 430 can notify security or another employee to investigate the matter further.

In another embodiment, controller and authentication engine 436 can also conduct another confirmation by determining whether the DP transmitted by wireless mobile device (M) 420 has already been used by another wireless mobile device. In this embodiment, controller and authentication engine 436 can include a list of all DPs which have been previously used, thus are currently invalid. If the DP is invalidated, then the BEDP transmitted by wireless mobile device (M) 420 is invalid. If the DP has not been previously used and invalidated, then the DP is valid.

In like manner, as an alternative, controller and authentication engine 436 can include a unique transaction identification within the DP. Once the unique transaction identification pattern is used, then the transaction identification is invalidated. Controller and authentication engine 436 will consider any future DPs transmitted with the invalidated transaction identification invalid.

As another alternative, controller and authentication engine 436 can verify that the DP transmitted by wireless mobile device (M) 420 is temporarily correct. In this embodiment, controller and data pattern (DP) generator 412 can include a date stamp, a time stamp, or both a date and time stamp within the DP. Controller and authentication engine 436 can verify whether the date and time stamps within the DP transmitted by wireless mobile device (M) 420 match the date and time stamps transmitted by data processing system 410. If the date and time stamps match, then the transaction and the data pattern are valid.

In another embodiment, confirmation device 430 does not receive the BEDP from data processing system 410 but only receives the BEDP from wireless mobile device (M) 420. Thus, to authenticate in this embodiment, confirmation device 430 decrypts the BEDP using the BE public key 432. If confirmation device 430 is able to decrypt the BEDP, then the transaction is valid and confirmation device 430 assigns a confirmed status to wireless mobile device (M) 420, thereby permitting the user of wireless mobile device (M) 420 to leave the premises of the business entity. If confirmation device 430 is not able to decrypt, then the transaction is invalid and confirmation device 430 notifies the business entity of a need to investigate further.

In yet another embodiment, wireless mobile device (M) 420 can also encode the DP transmitted by wireless mobile device (M) 420 using M private key 424. In this embodiment, encoder 422 would include M private key 424 from which encoder 422 would encrypt the BEDP. Upon receipt of the data pattern, decoder 431 can decrypt the data pattern from wireless mobile device (M) 420 using M public key 433, and then subsequently decrypt the DP for a second time using BE public key 432. If confirmation device 430 is not able to decrypt the BEDP from wireless mobile device (M) 420 with either BE public key 432 or M public key 433, then the business entity is notified of a need to investigate further. If confirmation device 430 is able to fully decrypt the BEDP, then wireless mobile device (M) 420 is assigned a confirmed status, and typically the user of wireless mobile device 420 is permitted to leave the business entity premises.

In still yet another embodiment, instead of transmitting the BEDP, wireless mobile device (M) 420 can transmit a mobile data pattern (MDP) which is similar to the DP. Confirmation device 430 can use a predetermined method to authenticate and validate the MDP. If confirmation device 430 is able to authenticate and validate the MDP, then the user is permitted to leave the business entity premises.

The illustrative embodiments are not limited to the illustrated example. For example, data processing system 410, wireless mobile device (M) 420, and confirmation device 430 can include more or fewer components. Additionally, validation system 400 can include more or fewer wireless mobile units similar to wireless mobile device (M) 420. Additionally, wireless mobile device (M) 420 and confirmation device 430 can take forms other than the illustrated embodiment. In addition, validation system 400 may implement an encryption system other than a public/private key cryptography system. Furthermore, validation system 400 may use different DPs than those illustrated. Moreover, validation system 400 may not include an encryption system at all. Thus, validation system 400 may communicate and validate the instances of the DPs in an unencrypted form.

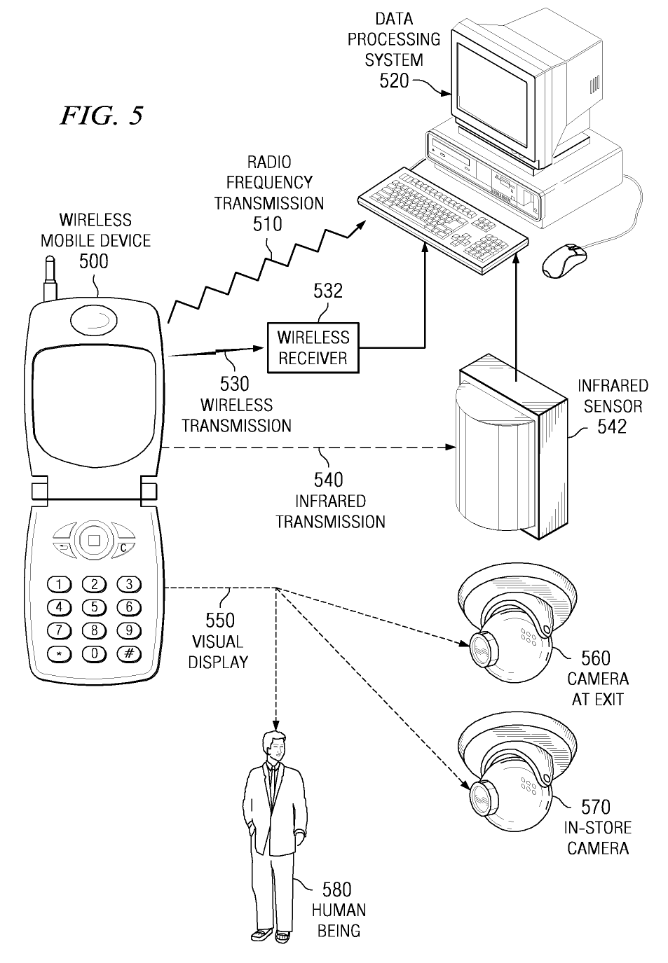

FIG. 5 graphically illustrates various illustrative embodiments for authenticating a confirmation, in accordance with an illustrative embodiment. Wireless mobile device 500 is similar to wireless mobile device 104 of FIG. 1, wireless mobile device 300 of FIG. 3, and wireless mobile device 420 of FIG. 4. Wireless mobile device 500 includes a confirmation device, similar to controller and data pattern confirmer 428 of FIG. 4. The confirmation device indicates the completion of a transaction by a user using wireless mobile device 500. The confirmation device in wireless mobile device 500 does at least one of the following: (1) sends a transmission to a data processing system for the business entity, (2) visually displays the confirmation on wireless mobile device 500, and (3) audibly transmits a confirmation on wireless mobile device 500.

A business entity authenticates the confirmation using a confirmation device, similar to confirmation device 430 of FIG. 4. A business entity authenticates the confirmation to verify that the transaction was actually completed. In the illustrative embodiment, a business entity authenticates the confirmation to verify that a transaction to purchase a product is approved and completed. In other words, the business entity verifies that a successful transaction was completed prior to leaving the premises of the business entity.

The type of confirmation device employed by the business entity depends on the type of confirmation employed by the confirmation device in wireless mobile device 500. The form of the confirmation is identified in the authentication form in the data pattern.

In one embodiment, wireless mobile device 500 transmits radio frequency transmission 510 to data processing system 520. In this embodiment, radio frequency transmission 510 is used to communicate data patterns. Data processing system 520 is the confirmation device for the business entity. In this embodiment, data processing system 520 is a network computer, similar to clients 110, 112, and 114 of FIG. 1 and data processing system 200 of FIG. 2. In use, data processing system 520 receives and processes radio frequency transmission 510 which represents a data pattern for wireless mobile device 500. If a public/private key cryptography system is employed, data processing system 520 decrypts radio frequency transmission 510. In the illustrative embodiment, the authentication form can be any easily recognizable pattern of alphanumeric characters, such as the date and time of the transaction, a code word for the business entity, or a unique set of characters specific to the business entity. The authentication form can also be a symbol, such as a check mark “√” or a smiley face. Thus, depending on implementation, either data processing system 520 can automatically execute a set of instructions to confirm the authorization form or an employee of the business entity can visually authenticate the transaction identification displayed on data processing system 520.

In another embodiment, wireless mobile device 500 sends wireless transmission 530 to wireless receiver 532, which is coupled to data processing system 520. In this embodiment, wireless transmission 530 is a wireless confirmation transmitting the data pattern. As in the previous embodiment, data processing system 520 is the confirmation device. As in the previous embodiment, depending on implementation, either data processing system 520 can automatically execute a set of instructions to confirm the authorization form or an employee of the business entity can visually authenticate the transaction identification displayed on data processing system 520.

In yet another embodiment, wireless mobile device 500 sends infrared transmission 540 to infrared sensor 542, which then translates the information into an electrical signal for data processing system 520 to read. Similar to the previous embodiments, infrared transmission 540 is the confirmation device transmitting the data pattern, and data processing system 520 is the confirmation device. Depending on implementation, either data processing system 520 can automatically execute a set of instructions to confirm the authorization form or an employee of the business entity can visually authenticate the transaction identification displayed on data processing system 520.

In still yet another embodiment, the confirmation is visual display 550. Visual display 550 can be (1) a copy or part of a copy of the data pattern displayed on the screen of wireless mobile device 500, (2) a light emitting from the screen or number pad on wireless mobile device 500, or (3) a text message displayed on the screen of wireless mobile device 500. The light emitting from wireless mobile device 500 can vary in color, style, and frequency pattern. For example, the light may be solid or flashing. The text displayed on the screen can also be a word or a symbol. For example, the screen can display the word “APPROVED” or a large “√” symbol. Additionally, visual display 550 can dynamically change and vary based on a variety of factors, such as time of day, value of the purchased product, or the customer loyalty status of the user.

In the illustrative embodiment, visual display 550 is the confirmation device representing the data pattern. The confirmation device is either camera 560 which can be located at the exit, in-store camera 570, or human being 580. If camera at exit 560 is used, then a user holds up wireless mobile device 500 to camera 560 while visual display 550 is being displayed. In one embodiment, an employee, such as human being 580, views visual display 550 through camera 560. In another embodiment, camera 560 is coupled to data processing system 520. Data processing system 520 or an employee viewing data processing system 520 can then authenticate visual display 550.

In another embodiment, in-store camera 570 locates wireless mobile device 500. In-store camera 570 can either automatically find wireless mobile device 500 or the user can hold up wireless mobile device 500 to in-store camera 570 while visual display 550 is being displayed. In one embodiment, an employee, such as human being 580, views visual display 550 through in-store camera 570. In another embodiment, in-store camera 570 is coupled to data processing system 520. Data processing system 520 or an employee viewing data processing system 520 can then authenticate visual display 550.

In yet another embodiment, human being 580 can authenticate visual display 550. Human being 580 can be an employee of the business entity and situated anywhere in the business entity. Typically, human being 580 will be situated at the exit of the business entity to visually authenticate visual display 550. However, human being 580 can also be anywhere in the store as long as human being 580 can visually authenticate visual display 550.

In yet another embodiment, wireless mobile device 500 can transmit an audible confirmation (not shown) to human being 580. The audible confirmation can be any audible sound, such as a series of tones, a song, or an alarm.

In any of the above illustrative embodiments, if the transaction is invalid, the business entity may notify security personnel associated with the business entity or another employee within the business entity. Additionally, the business entity can choose to audit a user after notifying security or an employee. The audit can be implemented due to an unfavorable result in the authentication process or based on the customer loyalty status of the user. The business entity may also choose to randomly audit the user for security purposes as well.

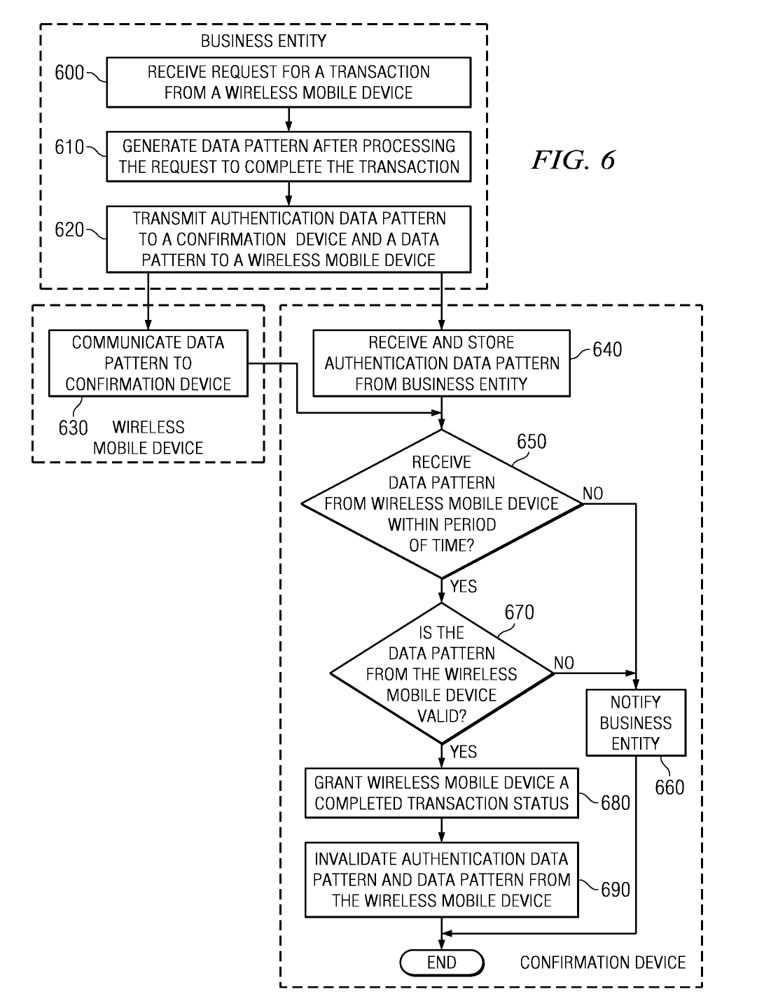

FIG. 6 is a flowchart illustrating the process for authenticating a transaction in which the confirmation device receives a data pattern from both the business entity and the wireless mobile device, in accordance with an illustrative embodiment. The following process is exemplary only and the order of the steps may be interchanged without deviating from the scope of the invention. The process is executed in a validation system, similar to validation system 400 of FIG. 4.

The process begins with a business entity receiving a request for a transaction from a wireless mobile device (step 600). The business entity then generates a data pattern after processing the request to complete the transaction (step 610). The business entity then transmits an authentication data pattern to a confirmation device and a data pattern to a wireless mobile device (step 620). In the illustrative embodiment, the data patterns sent to the confirmation device and the wireless mobile device are similar or in a known relationship. In an alternative embodiment, the data patterns may differ, but the confirmation device can still validate the data pattern transmitted by the wireless mobile device despite the differences.

The wireless mobile device communicates a data pattern to the confirmation device (step 630). The data pattern is generated after processing the data pattern transmitted by the business entity. In processing, the wireless mobile device receives and reads the information from the data pattern. After reading the information, wireless mobile device executes instructions to communicate some or all of the data pattern to the confirmation device. The data pattern sent from the wireless mobile device to the confirmation device may differ from that transmitted by the business entity, but may be related to it in a known way. The form of communication of the data pattern depends on the authentication form identified in the data pattern. Depending on implementation, the authentication form can be a visual confirmation, an audio confirmation, or a wireless transmission.

The confirmation device receives and stores the authentication data pattern from the business entity (step 640). The confirmation device then monitors transmissions of data patterns from all the wireless mobile devices and determines whether a data pattern is received from the wireless mobile device within a certain period of time (step 650). If no transmission is received from the wireless mobile device (“no” output to step 650), then the confirmation device notifies the business entity (step 660). The business entity can notify security personnel or another employee to investigate the matter further. The process terminates thereafter.

Returning to step 650, if a transmission is received from the wireless mobile device within a certain period of time (“yes” output to step 650), then the confirmation device determines whether the data pattern from the wireless mobile device is valid (step 670). If the data pattern is not valid (“no” output to step 670), then the confirmation device notifies the business entity (step 660). The business entity can notify security personnel or another employee to investigate the matter further. The process terminates thereafter.

Returning to step 670, if the data pattern from the wireless mobile device is valid (“yes” output to step 670), then the confirmation device grants the wireless mobile device a completed transaction status (step 680). Typically, this allows the user of wireless mobile device to leave the business entity. The confirmation device then invalidates the authentication data pattern and the data pattern from the wireless mobile device so that no other customer can use the same data patterns (step 690), with the process terminating thereafter.

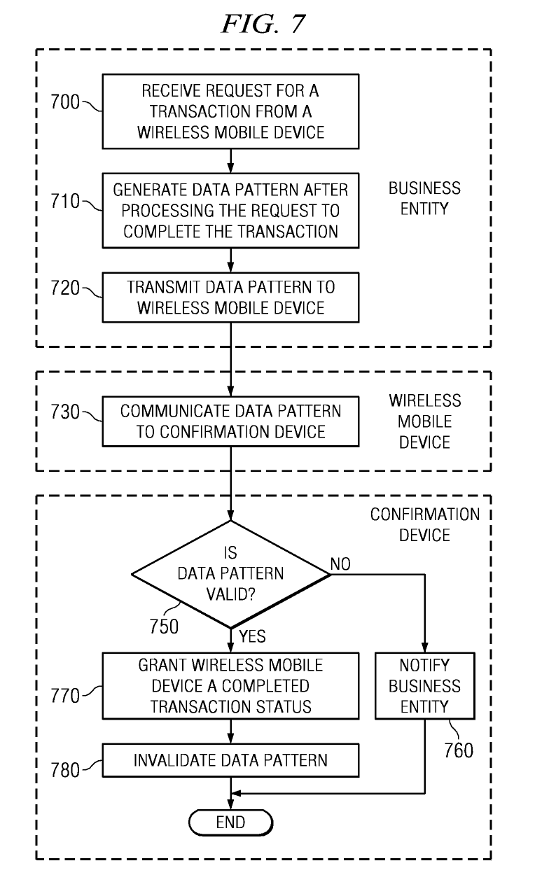

FIG. 7 is a flowchart illustrating the process for authenticating a transaction in which the confirmation device receives a data pattern only from the wireless mobile device, in accordance with an illustrative embodiment. The following process is exemplary only and the order of the steps may be interchanged without deviating from the scope of the invention. The process is executed in a validation system, similar to validation system 400 of FIG. 4.

The process begins with a business entity receiving a request for a transaction from a wireless mobile device (step 700). The business entity generates a data pattern after processing the request to complete the transaction (step 710). The business entity then transmits the data pattern to the wireless mobile device (step 720).

The wireless mobile device then communicates the data pattern to the confirmation device (step 730). The data pattern is generated by the wireless mobile device after processing the data pattern transmitted by the business entity. The data pattern generated by the wireless mobile device is related to the data pattern transmitted by the business entity in a known way. The confirmation device then determines whether the data pattern is valid (step 750). If the data pattern is not valid (“no” output to step 750), then the confirmation device notifies the business entity (step 760). The business entity can notify security personnel or another employee to investigate the matter further. The process terminates thereafter.

Returning to step 750), if the data pattern is valid (“yes” output to step 750), then the confirmation device grants the wireless mobile device a completed transaction status (step 770), and typically allows the user of the wireless mobile device to leave the premises of the business entity. The confirmation device then invalidates the data pattern so that no other user can use the same data pattern (step 780), with the process terminating thereafter.

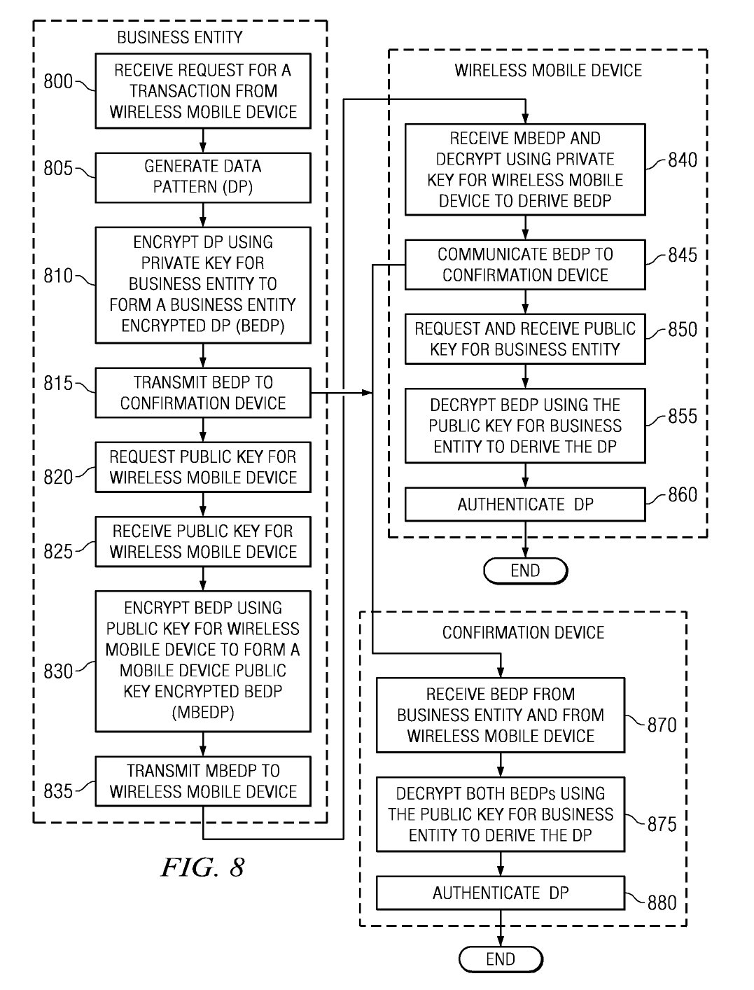

FIG. 8 is a flowchart illustrating the method for creating a secure data pattern for a validation system in which the confirmation device receives a data pattern from both the business entity and the wireless mobile device, in accordance with an illustrative embodiment. The following process is exemplary only and the order of the steps may be interchanged without deviating from the scope of the invention. The process is executed in a validation system, similar to validation system 400 of FIG. 4.

The process begins with a business entity receiving a request for a transaction from a wireless mobile device (step 800). The business entity then generates a data pattern (DP) (step 805). The business entity then encrypts the DP using the private key for the business entity to form a business entity encrypted DP (BEDP) (step 810). The business entity then transmits the authentication data pattern or BEDP to a confirmation device (step 815).

The business entity then requests a public key for the wireless mobile device (step 820). The business entity receives the public key for the wireless mobile device (step 825) and encrypts the BEDP using the public key for the wireless mobile device to form a mobile device public key encrypted BEDP (MBEDP) (step 830). The DP has now been encrypted twice. The business entity then transmits the MBEDP to the wireless mobile device (step 835).

The wireless mobile device then receives the MBEDP from the business entity and decrypts the MBEDP using the private key for the wireless mobile device to derive the BEDP (step 840). Then the wireless mobile device communicates the BEDP to the confirmation device (step 845). At this point, both the business entity and the wireless mobile device have sent an instance of the BEDP to the confirmation device.

The wireless mobile device then requests and receives the public key for the business entity (step 850). The wireless mobile device decrypts the BEDP using the public key for the business entity to derive the DP (step 855). The wireless mobile device then authenticates the DP (step 860). The wireless mobile device can then optionally display the entire data pattern or a portion of a formatted copy of the data pattern so that the user can verify the accuracy of the information in the data pattern. In an alternative embodiment, the wireless mobile device can also optionally display a representation of the data pattern, such as an icon. The process terminates thereafter.

Returning to steps 815 and 845, the confirmation device receives an instance of the BEDP from the business entity and an instance of the BEDP from the wireless mobile device (step 870). The confirmation device then decrypts both instances of the BEDP using the public key for the business entity to derive the DP (step 875). The confirmation device then authenticates the DP (step 880). The authentication of the DP confirms that a transaction was completed using the wireless mobile device. In one embodiment, the authentication is just the confirmation that the data pattern can be decrypted by the public key of the business entity. If both instances of the BEDP can be decrypted using the public key for the business entity, then both instances of the BEDP are authentic communications from the business entity. In another embodiment, the authentication also includes a validation step by determining whether the BEDP from the business entity matches the BEDP from the wireless mobile device. In yet another embodiment, the validation is a verification of a unique transaction identification match. In still yet another embodiment, the validation is verification that the date stamp, time stamp, or the date and time stamps in the data pattern transmitted by the wireless mobile device match the current date and time or the date and time recorded in the data pattern transmitted by the business entity. In still yet another embodiment, the validation is verification that the authentication data pattern BEDP from the business entity is related to the data pattern from the wireless device using a known relationship. The process terminates thereafter.

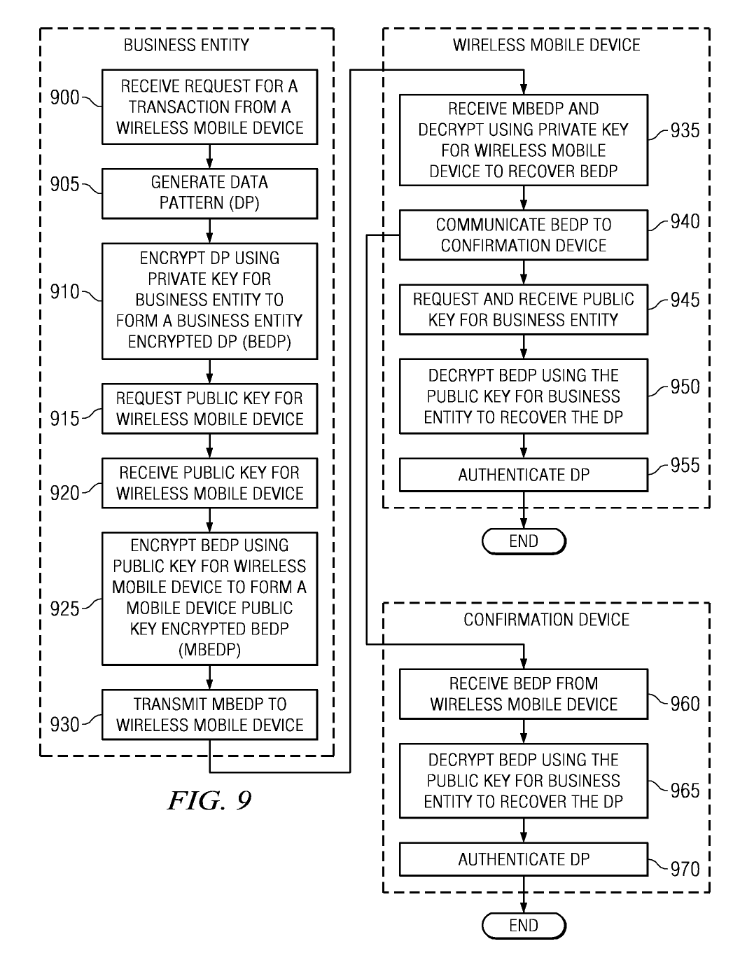

FIG. 9 is a flowchart illustrating the method for creating a secure data pattern for a validation system in which the confirmation device receives a data pattern only from the wireless mobile device, in accordance with an illustrative embodiment. The following process is exemplary only and the order of the steps may be interchanged without deviating from the scope of the invention. The process is executed in a validation system, similar to validation system 400 of FIG. 4.

The process begins with a business entity receiving a request for a transaction from a wireless mobile device (step 900). The business entity then generates a data pattern (DP) (step 905). The business entity then encrypts the DP using the private key for the business entity to form a business entity encrypted DP (BEDP) (step 910).

The business entity then requests a public key for a wireless mobile device (step 915). The business entity receives the public key for the wireless mobile device (step 920) and encrypts the BEDP using the public key for the wireless mobile device to form a mobile device public key encrypted BEDP (MBEDP) (step 925). The DP has now been encrypted twice. The business entity then transmits the MBEDP to the wireless mobile device (step 930).

The wireless mobile device then receives the MBEDP from the business entity and decrypts the MBEDP using the private key for the wireless mobile device to recover the BEDP (step 935). Then, the wireless mobile device communicates the BEDP to a confirmation device (step 940). The wireless mobile device then requests and receives the public key for the business entity (step 945). The wireless mobile device decrypts the BEDP using the public key for the business entity to recover the DP (step 950). The wireless mobile device then authenticates the DP (step 955). The wireless mobile device can then optionally display the entire data pattern or a portion of a formatted copy of the data pattern so that the user can verify the accuracy of the information in the data pattern. The process terminates thereafter.

Returning to step 940, the confirmation device receives the BEDP from the wireless mobile device (step 960). The confirmation device then decrypts the BEDP using the public key for the business entity to recover the DP (step 965). The confirmation device then authenticates the DP (step 970). The authentication of the DP confirms that the message is an authentic communication from the business entity to the wireless mobile device. In alternative embodiments, the confirmation device can further validate the data pattern by validating a unique transaction identifier within the data pattern or the date and time stamps within the data pattern. The process terminates thereafter.

Thus, the illustrative embodiments provide a user with the ability to complete a transaction without the use of a paper receipt. After purchasing a product, business entities can authenticate the purchase either visually, audibly, or through a wireless transmission. Customers do not need to locate a station to print a receipt. Customers also do not need to wait for an employee to address any issues associated with printing the receipt.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for authenticating transactions, the method comprising:
receiving, by a confirmation device, an authentication data pattern from a data processing system, wherein the authentication data pattern is generated in response to completing a transaction processed by the data processing system;
responsive to receiving the authentication data pattern from the data processing system, monitoring a transmission comprising a data pattern from a wireless mobile device; and
responsive to receiving the transmission comprising the data pattern from the wireless mobile device, authenticating the data pattern from the wireless mobile device using an authentication form.

2. The method of claim 1, further comprising:
responsive to an absence of receiving a transmission comprising the data pattern from the wireless mobile device within a period of time, notifying a business entity to investigate further.

3. The method of claim 1, wherein the step of authenticating the data pattern comprises:
comparing the data pattern from the wireless mobile device with the authentication data pattern; and
responsive to an absence of a match, notifying a business entity to investigate further, wherein the match is a known relationship between the authentication data pattern and the data pattern from the wireless mobile device.

4. The method of claim 1, wherein the authentication data pattern is encrypted using a private key for a business entity to form an encrypted authentication data pattern, and wherein the data pattern from the wireless mobile device is encrypted using the private key for the business entity to form an encrypted data pattern.

5. The method of claim 4, further comprising:
responsive to receiving the encrypted authentication data pattern, decrypting the encrypted authentication data pattern using a public key for the business entity; and
responsive to receiving the encrypted data pattern, decrypting the encrypted data pattern using the public key for the business entity.

6. The method of claim 4, further comprising:
responsive to receiving by the confirmation device a twice-encrypted data pattern from the wireless mobile device, decrypting the twice-encrypted data pattern using a public key for the wireless mobile device and a public key for the business entity, wherein the twice-encrypted data pattern is formed by encrypting the encrypted data pattern using a private key for the wireless mobile device.

7. The method of claim 4, wherein the encrypted data pattern is encrypted a second time using a public key for the wireless mobile device to form a twice-encrypted data pattern, and wherein the wireless mobile device decrypts the twice-encrypted data pattern using a private key for the wireless mobile device and a public key for the business entity.

8. The method of claim 1, wherein the authentication form is at least one of a visual confirmation, an audible confirmation, or a wireless transmission.

9. The method of claim 1, wherein the confirmation device is at least one of a computer, a personal digital assistant, a wireless mobile device, an infrared sensor, a camera, and a human being.

10. A confirmation device comprising:
a storage device for storing an authentication data pattern transmitted from a data processing system, wherein the authentication data pattern is generated in response to completing a transaction processed by the data processing system; and
an authentication engine connected to the storage device, wherein the authentication engine monitors received transmissions comprising a data pattern from a wireless mobile device in response to receiving the authentication data pattern from the data processing system, and wherein the authentication engine authenticates the data pattern from the wireless mobile device using an authentication form in response to receiving the transmission comprising the data pattern from the wireless mobile device.

11. The confirmation device of claim 10, wherein the authentication engine notifies a business entity to investigate further in response to an absence of receiving a transmission comprising the data pattern from the wireless mobile device within a certain period of time.

12. The confirmation device of claim 10, wherein the authentication engine compares the data pattern from the wireless mobile device with the authentication data pattern, and wherein the authentication engine notifies the business entity to investigate further in response to an absence of a match, wherein the match is a known relationship between the authentication data pattern and the data pattern from the wireless mobile device.

13. The confirmation device of claim 10, further comprising:
a decoder connected to the authentication engine, wherein the decoder decrypts the authentication data pattern and the data pattern from the wireless mobile device using a public key for a business entity, and wherein the authentication data pattern and the data pattern from the wireless mobile device are encrypted using a private key for the business entity.

14. The confirmation device of claim 10, wherein the confirmation device is at least one of a computer, a personal digital assistant, a wireless mobile device, an infrared sensor, a camera, and a human being.

15. A computer program product comprising a computer usable medium having computer usable program code for authenticating transactions, the computer program product comprising:
computer usable program code for receiving, by a confirmation device, an authentication data pattern from a data processing system, wherein the authentication data pattern is generated in response to completing a transaction processed by the data processing system;
responsive to receiving the authentication data pattern from the data processing system, computer usable program code for monitoring a transmission comprising a data pattern from a wireless mobile device;
responsive to receiving the transmission comprising the data pattern from the wireless mobile device, computer usable program code for authenticating the data pattern from the wireless mobile device using an authentication form.

16. The computer program product of claim 15, further comprising:
responsive to an absence of receiving a transmission comprising the data pattern from the wireless mobile device within a certain period of time, computer usable program code for notifying a business entity to investigate further.

17. The computer program product of claim 15 further comprising:
computer usable program code for comparing the data pattern from the wireless mobile device with the authentication data pattern; and
responsive to an absence of a match, computer usable program code for notifying the business entity to investigate further, wherein the match is a known relationship between the authentication pattern and the data pattern from the wireless mobile device.

18. The computer program product of claim 15 wherein the authentication data pattern is encrypted using a private key for a business entity to form an encrypted authentication data pattern, and wherein the data pattern from the wireless mobile device is encrypted using the private key for the business entity to form an encrypted data pattern, and wherein the computer program product further comprises:
responsive to receiving the encrypted authentication data pattern, computer usable program code for decrypting the encrypted authentication data pattern using a public key for the business entity; and
responsive to receiving the encrypted data pattern, computer usable program code for decrypting the encrypted data pattern using the public key for the business entity.

19. The computer program product of claim 18, further comprising:
responsive to receiving by the confirmation device a twice-encrypted data pattern from the wireless mobile device, computer usable program code for decrypting the twice-encrypted data pattern using a public key for the wireless mobile device and the public key for the business entity, wherein the twice-encrypted data pattern is formed by encrypting the encrypted data pattern using a private key for the wireless mobile device.

20. The computer program product of claim 18, wherein the encrypted data pattern is encrypted a second time using a public key for the wireless mobile device to form a twice-encrypted data pattern, and wherein the wireless mobile device decrypts the twice-encrypted data pattern using a private key for the wireless mobile device and a public key for the business entity.
